(19) United States
(12) Patent Application Publication
(10) Pub. No.: US 2006/0105124 A1
(43) Pub. Date: May 18, 2006

(54) Laminated material, process for producing laminated material, method of heat sealing laminated material and packaging container

(75) Inventor: Hideyo Kikuchi, Gotemba-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Tetra Laval Holdings & Finance S.A., Pully (CH)

(21) Appl. No.: 10/520,255

(22) PCT Filed: Jul. 16, 2003
(86) PCT No.: PCT/JP03/09009

§ 371 Date: Aug. 22, 2005

(30) Foreign Application Priority Data
Jul. 19, 2002 (JP) 2002-211182
Feb. 28, 2003 (JP) 2003-053245

(51) Int. Cl. B32B 27/32

(52) U.S. Cl. 428/35.2

(57) ABSTRACT

In this laminated material, the method of producing the laminated material, the method of heat sealing the laminated material and the packaging container, running/using/operation of the whole packaging system are allowed efficient through diversion or transfer of parts of different packaging systems of aseptic packaging and chilled packaging and, further, they contribute to the saving of energy and materials and the reduction of production cost.

The laminated material is a web-form laminated material for packaging containers comprising a support layer 1 and a thermoplastic innermost layer 3. A conductive layer 2 is laminated between the support layer 1 and the thermoplastic innermost layer 3 at zones where heat-sealing is conducted by high-frequency induction heating so that the heat generated by induction heating is conducted to the innermost layer, and the conductive layer 2 comprises a thin film/formed layer substantially comprising a metallic conductive material.

### TECHNICAL FIELD

The present invention relates to a laminated material, a method of producing the laminated material, a method of heat sealing the laminated material and a packaging container.

### BACKGROUND ART

A web-form laminated material used for packaging containers comprising a support layer and a thermoplastic innermost layer in which a carbon black conductive layer is laminated between the support layer and the thermoplastic innermost layer at zones where heat-sealing is conducted by high-frequency induction heating for forming a container is known (for example, as described in JP-B No. 63-222). In the laminated material shown in FIG. 1, a support layer, a thermoplastic innermost layer and a carbon black conductive layer as an intermediate layer therebetween are constituted.

A packaging machine in which an attaching device for attaching an aluminum foil tape for high-frequency induction heating to a portion of a web-form laminated material to be heat sealed is disposed to conduct high-frequency induction heating the aluminum foil tape by high-frequency coils of a heater is described, for example, in JP No. 2694286.

Packaging paper containers for liquid foodstuffs are classified into aseptic packaging storable at a normal temperature and chilled packaging put under chilled distribution such as milk containers. Respective packaging laminated materials are generally produced as aseptic packaging and chilled packaging separately, and filled and packaged with liquid foodstuffs by separate sealing methods by means of separate filling and packaging machines.

However, even for different packaging systems of aseptic packaging and chilled packaging efficient running/employment/operation of the whole packaging system are allowed through diversion or transfer of parts of different packaging systems and, further, this contributes to the saving of energy and materials and the reduction of production cost.

### DISCLOSURE OF THE INVENTION

The present invention has an object of providing a laminated material, a method of producing the laminated material, a heat sealing method of the laminated material and a packaging container capable of solving the subject described above.

The laminated material and the packaging container according to the invention is a web-form laminated material used for packaging containers comprising a support layer and a thermoplastic innermost layer in which a conductive layer is laminated between the support layer and the thermoplastic innermost layer at zones where heat-sealing is conducted by high-frequency induction heating for forming the container so that the heat generated by induction heating is conducted to the innermost layer, and the conductive layer comprises a thin film/formed layer substantially comprising a metallic conductive material.

The thin film/formed layer in the invention means that it does not include metal foils such as aluminum foils and steel foils and means layer/film formed by the steps of vapor deposition, plating, printing, etc.

Thus, even for different packaging system of aseptic packaging and chilled packaging efficient running/employment/operation of the whole packaging system are allowed through diversion or transfer of parts of different packaging systems and, further, this contributes to the saving of energy and materials and the reduction of production cost.

### BRIEF DESCRIPTION OF DRAWINGS

FIG. 1 is a cross sectional view for a portion of a web-form laminated material as an embodiment according to the present invention.

FIG. 2 is a plan view for a portion of a web-form laminated material as an embodiment according to the invention.

FIG. 3 is a plan view showing the joining of laminated materials in an embodiment of the invention.

FIG. 4 is a schematic view for a packaging and filling machine used in the invention.

FIG. 5 is a schematic view for a transversal sealing device of a filling machine used in the invention.

### BEST MODE FOR CARRYING OUT THE INVENTION

Embodiments of the present invention are to be described specifically below.

The invention for the laminated material according to claim 1 of the invention is a web-form laminated material used for packaging containers comprising at least a support layer and a thermoplastic innermost layer, in which

a conductive layer is laminated between the support layer and the thermoplastic innermost layer at zones where heat-sealing is conducted by high-frequency induction heating for forming the container so that the heat generated by the induction heating is conducted to the innermost layer and

the conductive layer is a thin film/formed layer substantially comprising a metallic conductive material.

In the invention for the laminated material according to claim 2, the conductive layer is a printed layer of a conductive composition containing a conductive filler substantially comprising a metallic conductive material.

In the invention for the laminated material according to claim 3, the conductive layer is a plating layer comprising a metallic conductive material.

In the invention for the laminated material according to claim 4, the conductive layer is a metal vapor deposited layer comprising a metallic conductive material disposed on an vapor deposited tape.

In the invention for the laminated material according to claim 5, the conductive layer is a metal vapor deposited layer comprising a metallic conductive material disposed on the inner surface of a substrate film for an vapor deposited film laminated between the support layer and the thermoplastic innermost layer.

In the invention for the laminated material according to claim 6, the conductive layer is a metal vapor deposited layer comprising a metallic conductive material disposed on the outer surface of a substrate film of an vapor deposited film laminated between the support layer and the thermoplastic innermost layer.

The invention for the method of producing the laminated material according to claim 7 is a method of producing a web-form laminated material used for packaging containers comprising at least a support layer and a thermoplastic innermost layer which includes, providing a plurality of material rolls for the support layer, delivering web-form support layers successively from the material rolls, printing a conductive layer of a conductive composition containing a conductive filler directly or indirectly to the inner surface of the support layer at zones where heat-sealing is conducted by high-frequency induction heating for forming the container, printing a container design indirectly or directly to the outer surface of the web-form support layer, forming identical or different kind of single or multiple thermoplastic layers simultaneously or successively to the printed outer surface and inner surface of the web-form support layer, and then joining the top end of the web-form support layer at the upstream with the rear end of the web-form support layer at the downstream thereby forming a longer web-form support layer.

The invention for the method of producing the laminated material according to claim 8 is a method of producing a web-form laminated material used for packaging containers comprising at least a support layer and a thermoplastic innermost layer, which includes, providing a plurality of material rolls for the support layer, delivering web-form support layers successively from the material rolls, forming a plating layer comprising a metallic conductive material to the inner surface of the support layer at zones where heat-sealing is conducted by high-frequency induction heating for forming the container, printing a container design indirectly or directly to the outer surface of the web-form support layer, forming identical or different kind of single or multiple thermoplastic layers simultaneously or successively to the printed outer surface and inner surface of the web-form support layer, and joining the top end of the web-form support layer at the upstream with the rear end of the web-form support layer at the downstream thereby forming a longer web-form support layer.

The invention for the method of producing the laminated material according to claim 9 is a method of producing a web-form laminated material used for packaging containers comprising at least a support layer and a thermoplastic innermost layer, which includes, providing a plurality of material rolls for the support layer, delivering web-form support layers successively from the material rolls, laminating a vapor deposited film comprising a substrate film and a metal vapor deposited layer of a metallic conductive material formed on the inner surface or the outer surface of the substrate film to the inner surface of the support layer including zones where heat-sealing is conducted by high-frequency induction heating for forming the container, printing a container design indirectly or directly to the outer surface of the long web-form support layer, forming identical or different kind of single or multiple thermoplastic layers simultaneously or successively to the printed outer surface and inner surface of the web-form support layer, and joining the top end of the web-form support layer at the upstream with the rear end of the web-form support layer at the downstream, thereby forming a longer web-form support layer.

The invention for the method of heat sealing the laminated material according to claim 10 includes, providing a web-form laminated material that is the laminated material used for packaging containers comprising at least a support layer and a thermoplastic innermost layer, in which a conductive layer is laminated between the support layer and the thermoplastic innermost layer at zones where heat-sealing is conducted by high-frequency induction heating for forming the container so that the heat generated by the induction heating is conducted to the innermost layer, and the conductive layer is a printed layer formed by printing a conductive composition containing a conductive filler or a plating layer comprising a metallic conductive material, forming the web-form laminated material into a tubular shape and applying a longitudinal seal in the longitudinal direction, filling a liquid foodstuff in the laminated material tube, forming heat-sealed zones by the high-frequency induction heating every predetermined interval in the traversing direction of the filled tube, and cutting the center of each sealed zone, thereby forming individual containers.

The invention for the packaging container according to claim 11 is a packaging container formed of a laminated material comprising at least a support layer and a thermoplastic innermost layer in which a conductive layer of a thin film/formed layer substantially comprising a metallic conductive material is formed at zones where heat-sealing is conducted by high-frequency induction heating for forming the container, the innermost layer is melted or softened by the heat generated by the induction heating to form a sealing zone with the opposing softened or melted innermost layer.

The invention having the constitutions described above have the following functions.

The web-form laminated material used for packaging containers according to the invention is in an elongate strip-form (web-form) capable of forming a number of containers and, that enables filling-up and production of packaging containers continuously at a high speed.

In the invention, the support layer provides the packaging container and the laminated material with a physically mechanical strength and maintains and supports the shape and form, etc. thereof. The thermoplastic innermost layer is also the innermost layer for the wall of the container and is in direct contact with a liquid foodstuff to prevent permeation/moistening of liquid relative to the support layer of the container. Further, the innermost layer is melted and softened by heat to form sealing zones in the heat-sealing.

The conductive layer is a thin film/formed layer substantially comprising a metallic conductive material. The thin film/formed layer in the form means that it does not include metal foils such as aluminum foils and steel foils but is a layer/film formed by the steps of vapor deposition, plating, printing and the like. Since the conductive layer has electric conductivity, when a high-frequency current is applied to external coils, an induced current is generated by high-frequency induction in the conductive layer and the heat caused by the resistance melts and seals the plastic material (thermoplastic material/resin) of the adjacent innermost layer. That is, in the invention, the conductive layer is inductively heated by high-frequency induction heating upon formation of the container, the generated heat is conducted to the innermost layer, by which the thermoplastic innermost layer is heated and melted and softened. At the heated regions, heat seal zones are formed.

In a preferred embodiment of the invention, the conductive layer is a printed layer formed by printing a conductive composition containing a conductive filler substantially comprising a metallic conductive material.

The conductive filler used in the invention can include, for example, metal powder such as iron, copper, brass, zinc, lead, titanium, aluminum, stainless steel, tungsten and alloys thereof etc., gold, silver, silver plated copper powder, silver-copper composite powder, silver-copper alloy, amorphous copper, nickel, chromium, palladium, aluminum, molybdenum or platinum, inorganic powders covered with such metals, powders of metal oxide such as of silver oxide and indium oxide, powders covered with such metal oxides, metal fibers, carbon fibers etc., carbon black, graphite and the like. However, it is desirable to properly select them depending on the application or the like.

In a preferred embodiment of the invention, silver is preferred among the conductive materials since it is highly conductive and shows less increase of the resistance value due to oxidation. Carbon black or graphite is preferred in view of the reduced weight. Further, a metal powder or metal flake is used preferably in case of avoiding black color. Further, two or more kinds of such conductive fillers may be used together.

The shape of the conductive material may be any of granular, spherical, flaky, scaly, platy, dendritic or cubic shape. The dendritic, scaly or flaky shape is preferred in view of contact between conductive materials with each other and the fluidity of the conductive paste.

The content of the conductive material in the conductive layer of the invention is from 5 to 95% by weight based on the conductive paste. In case where the content of the conductivity material exceeds 95% by weight, the coating film formed by using a conductive paste becomes fragile and the conductive is also lowered. In case where it is less than 5% by weight, no sufficient conductivity can be obtained. The content of the conductive material is preferably from 60 to 90% by weight.

In a preferred embodiment of the invention, the conductive layer is a plating layer comprising a metallic conductive material.

The metal used for plating in this embodiment can include those metals such as iron, copper, brass, zinc, lead, titanium, aluminum, stainless steel, tungsten and alloys thereof, gold, silver, silver-copper alloy, amorphous copper, nickel, chromium, palladium, aluminum, molybdenum and platinum. In a preferred embodiment of the invention, silver is preferred among the conductive materials, since it is highly conducted and shows less increase of the resistance value due to oxidation. The plating method includes various methods, for example, an electroless plating method, and they can be selected and changed properly depending on the application.

In the preferred embodiment of the invention, the conductive layer is a metal vapor deposited layer comprising a metallic conductive material disposed on a vapor deposited tape.

In this embodiment, it is possible to use a vapor deposited tape obtained by vacuum evaporating a metal, for example, metallic aluminum, aluminum alloy or the like to the outer surface of a substrate film such as formed of polyethylene or polyester. Various methods can be adopted for the method of metal vapor deposition and for the thickness of the vapor deposited layer. For example, a vacuum vapor deposition method, a sputtering method, a plasma method and the like are used for the vapor deposition method.

The vapor deposited tape is reduced in the layer thickness because of vapor deposition and is excellent in the flexibility and operationality compared with an aluminum foil tape or composite tape of an aluminum foil. Accordingly, the vapor deposited tape can be used also in high speed packaging and filling machines.

In a preferred embodiment of the invention, the conductive layer is a metal vapor deposited layer comprising a metallic conductive material disposed on the inner surface of a substrate film of an vapor deposited film laminated between a support layer and a thermoplastic innermost layer.

In this embodiment, the layer constitution for the web-form laminated material used for packaging containers comprises support layer/vapor deposited film (substrate film/metal vapor deposited layer)/thermoplastic innermost layer, from the outside to the inner side. In this embodiment, the metal vapor deposited layer is disposed on the inner side.

The advantage of this embodiment is that the vapor deposited film can be laminated not only at the zones where heat-sealing is conducted by high-frequency induction heating for forming the container but also substantially over the entire surface of the laminated material. Accordingly, formation of the conductive layer and formation of a barrier layer of the invention can be conducted simultaneously by laminating the vapor deposited film instead of the conventional laminate (lamination layer) of the aluminum foil in the production step of the laminated material.

In the preferred embodiment of the invention, the conductive layer is a metal vapor deposited layer comprising a metallic conductive material disposed on the outer surface of the substrate film of the vapor deposited film laminated between the support layer and the thermoplastic innermost layer.

In this embodiment, the layer constitution of the web-form laminated material used for packaging containers comprises support layer/vapor deposited film (metal vapor deposited layer/substrate film)/thermoplastic innermost layer, from the outside to the inner side. In this embodiment, the metal vapor deposited layer is disposed on the outside of the vapor deposited film.

The advantage of this embodiment is that the vapor deposited film can be laminated not only to the zones where heat-sealing is conducted by the high-frequency induction heating for forming the container but also substantially over the entire surface of the laminated material like the embodiment as described above. Accordingly, formation of the conductive layer and formation of the barrier layer can be conducted simultaneously by laminating the vapor deposited film in the production of the laminated material.

Further, by adding a white masking agent to the substrate film, the metallic luster color of the metal vapor deposited layer can be masked.

In a method of producing a web-form laminated material in a preferred embodiment of the invention, a plurality of material rolls for the support layer are at first provided.

Web-form support layers are successively delivered from the material roll and a conductive layer of a conductive composition containing a conductive filler is printed directly or indirectly to the inner surface of the support layer at the zones where heat-sealing is conducted by high-frequency induction heating for forming the container. The conductive composition is pasty upon printing and the paste can be coated once or more times for printing. The thickness of the conductive layer, etc. can be controlled according to the viscosity of the paste or the number of coating steps.

Then, for the web, a container design is printed indirectly or directly to the outer surface of the web-form support layer in the printing step. Here, the phrase of “indirectly or directly” means that a plastic laminate layer, a film layer, an adhesive layer or an anchor coat layer may also be laminated between the printed layer for the design and the support layer surface.

Identical or different kind of single or multiple thermoplastic layers are formed simultaneously or successively to the printed outer surface and inner surface of the web-form support layer. As a result, single or multiple outermost layers and innermost layers are formed. Further, for facilitating the formation of the container in the midway step, ruled lines (creases) are formed optionally to the laminated material.

In this embodiment, the top end of the web-form support layer at the upstream and the rear end of the web-form support layer at the downstream can be joined to form a longer web-form support layer. The obtained web can be stored also as a roll. Further, it can be continuously supplied to the downstream step without storage. The step can be conducted before and after the step of printing the conductive layer, before and after the printing step of the container design and before and after the step of forming the innermost layer and the outermost layer in this method.

In the method of producing the web-form laminated material in the preferred embodiment of the invention, a plurality of material rolls for the support layer are also provided.

Then, the web-form support layers are successively delivered from the material rolls, a plating layer comprising a metallic conductive material is formed to the inner surface of the support layer at zones where heat-sealing is conducted by high-frequency induction heating for forming the containers, a container design is printed indirectly or directly to the outer surface of the web-form support layer, identical or different kind of single or multiple thermoplastic layers are formed simultaneously or successively to the printed outer surface and inner surface of the web-form support layer, the top end of the web-form support layer at the upstream and the rear end of the web-form support layers at the downstream are joined to form a longer web-form supplied layer.

For example, the plating layer can be formed by electroless plating. In the electroless plating, a compound soluble to a solvent (generally, water) containing a metal to be precipitated and a reducing agent are dissolved in a liquid, a substrate is dipped into the liquid to precipitate the metal on the surface of the substrate.

In a method of producing the web-form laminated material in the preferred embodiment of the invention, a plurality of material rolls for the support layers are provided, the web-form support layers are successively delivered from the material rolls, an vapor deposited film comprising a substrate film and a metal vapor deposited layer of a metallic conductive material formed to the inner surface or the outer surface of the substrate film is laminated to the inner surface of the support layer including zones where heat-sealing is conducted by high-frequency induction heating for forming the container, a container design is printed indirectly or directly to the outer surface of the long web-form support layer, identical or different kind of single or multiple thermoplastic layers are formed simultaneously or successively to the printed outer surface and inner surface of the web-form support layers, the top end of the web-form support layer at the upstream and the rear end of the web-form support layer at the downstream are joined to form a longer web-form support layer.

The advantage of the embodiment is that the vapor deposited film can be laminated not only to zones where heat-sealing is conducted by the high-frequency induction heating for forming the container but also substantially over the entire surface of the laminated material as described above, the vapor deposited film can be laminated instead of the conventional laminate (lamination layer) of the aluminum foil in the production step of the laminated material, and formation of the conductive layer and formation of the barrier layer can be conducted simultaneously in the invention.

The method of heat sealing the laminated material according to the invention provides the laminated material of the invention, that is, a web-form laminated material comprising a support layer and a thermoplastic innermost layer, in which a conductive layer is laminated between the support layer and the thermoplastic innermost layer at zones where heat-sealing is conducted by high-frequency induction heating for forming the container so that the heat generated by the induction heating is conducted to the innermost layer and the conductive layer is a printed layer formed by printing a conductive composition containing a conductive filler, or a plating layer comprising a metallic conductive material. The web-form laminated material is usually taken-up as a rolled form and stored or conveyed.

For example, a rolled web-form laminated material is loaded to a packaging and filling machine, and the laminated material is delivered from the roll and then conveyed into the filling machine. The web-form laminated material under conveyance is formed into a tubular shape during lowering. A longitudinal seal is applied to the longitudinal direction of the laminated material to provide a liquid tight state with no liquid leakage. In case of applying the longitudinal sealing by the high-frequency induction heating, heat-sealing zones are formed by the high-frequency induction heating.

A liquid foodstuff is filled fully in the laminated material tube.

Heat-sealing zones are formed by the high-frequency induction heating every predetermined interval in the traversing direction of the filled tube and, preferably, under a liquid surface and transversal sealing is done. Then, the center of the sealing zones is cut, for example, by a cutter knife to form individual containers and, optionally, it is folded along the creases into a final shape.

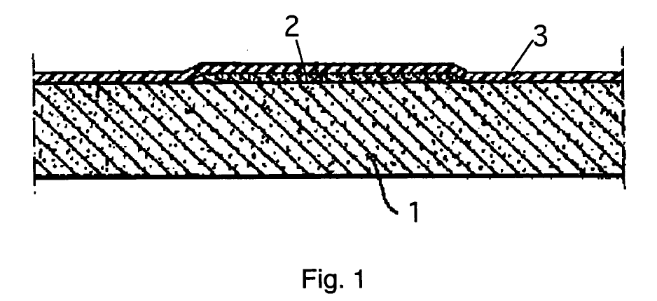

Then, preferred embodiments of the invention are to be described with reference to FIG. 1 to FIG. 5.

### EMBODIMENT 1

FIG. 1 shows a cross sectional view for a portion of a web-form laminated material as an embodiment according to the invention. In FIG. 1, the laminated material comprises a support layer 1 made of paper, card board, plastic material or a composite material thereof, a thermoplastic innermost layer 3 such as one made of low density polyethylene or linear chain low density polyethylene, and a conductive layer 2 laminated between the support layer 1 and the thermoplastic innermost layer 3 so that the heat generated by induction heating at the zones where heat-sealing is conducted by the high-frequency induction heating is conducted to the innermost layer 3.

The conductive layer is a printed layer printed with a conductive composition containing a conductive filler substantially comprising a metallic conductive material, or a plating layer comprising a metallic conductive material.

The conductive filler used in the invention can include, for example, metal powder such as iron, copper, brass, zinc, lead, titanium, aluminum, stainless steel, tungsten and alloys thereof, gold, silver, silver plated copper powder, silver-copper composite powder, silver-copper alloy, amorphous copper, nickel, chromium, palladium, aluminum, molybdenum or platinum, inorganic powders covered with such metals, powders of metal oxide such as of silver oxide and indium oxide, powders covered with such metal oxides, metal fibers, carbon fibers etc., carbon black, graphite and the like. However, it is desirable to properly select them depending on the application or the like.

In a preferred embodiment of the invention, silver is preferred among the conductive materials since it is highly conductive and shows less increase of the resistance value due to oxidation. Carbon black or graphite is preferred in view of the reduced weight. Further, a metal powder or metal flake is used preferably in case of avoiding black color. Further, two or more kinds of such conductive fillers may be used together.

The shape of the conductive material may be any of granular, spherical, flaky, scaly, platy, dendritic or cubic shape. The dendritic, scaly or spherical shape is preferred in view of contact between conductive materials with each other and the fluidity of the conductive paste.

The content of the conductive material in the conductive layer of the invention is from 5 to 95% by weight based on the conductive paste. In case where the content of the conductive material exceeds 95% by weight, the coating film formed by using a conductive paste becomes fragile and the conductivity is also lowered. In case where it is less than 5% by weight, no sufficient conductivity can be obtained. The content of the conductive material is preferably from 60 to 90% by weight.

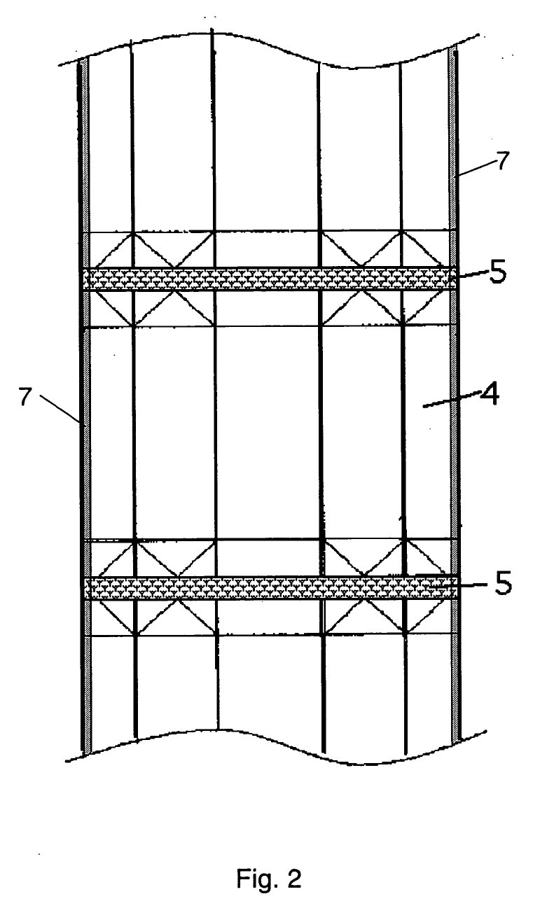

FIG. 2 is a plan view showing a portion of a web-form laminated material as an embodiment of the invention. In FIG. 2, a web-shaped laminated material 4 is a laminated material of a support layer comprising paper, plastic or a composite material thereof and a thermoplastic layer such as one formed of low density polyethylene. A plurality of packaging containers are obtained from the laminated material in which a portion between two sealing zones 5 for transversal sealing in the transversal direction corresponds to one packaging container. A conductive layer is laminated between the support layer and the thermoplastic innermost layer so that the heat generated by the induction heating at the zones 5 where the heat-sealing is conducted by the high-frequency induction heating is conducted to the innermost layer.

In case of longitudinal sealing by high-frequency induction heating, the conductive layer is laminated also at both end portions 7 of the web-form laminated material so as to form heat-sealing zones by the high-frequency induction heating.

The conductive layer is laminated to the zones 5 and the vicinity thereof as shown in FIG. 2, as well as also to both end portions 7 and 7 in case of applying a longitudinal sealing by the high-frequency induction heating.

### EMBODIMENT 2

In the method of producing a web-form laminated material of the embodiment according to the invention, a plurality of paper material rolls are provided.

Web-form support layers are successively delivered from the material rolls, a conductive layer of a conductive composition containing a conductive filler such as an aluminum foil powder or iron powder is printed in a great amount repetitively (about once to seven times) directly or indirectly to the inner surface of the support layer at zones 5 where heat-sealing is conducted by the high-frequency induction heating for forming the container and portions somewhat before and behind thereof and printed once or several times. The thickness, etc. of the conductive layer can be controlled, for example, by the viscosity and the number of coating steps of the paste. A resin enhancing the electric conductivity can also be incorporated into the ink if it is necessary for enhancing the electric conductivity.

A method of sufficiently coating a conductive layer (ink) intermittently for enabling sealing to the rear face of the web-form laminated packaging material and applying a commodity design and creases (folds), etc. on the surface can be conducted easily on every one roll if this is a low speed process. However, for applying printing and folds, etc. at high speed, it is necessary to provide a web-form laminated material applied with seal printing at the rear face in a highly standarized state continuously on a printing machine.

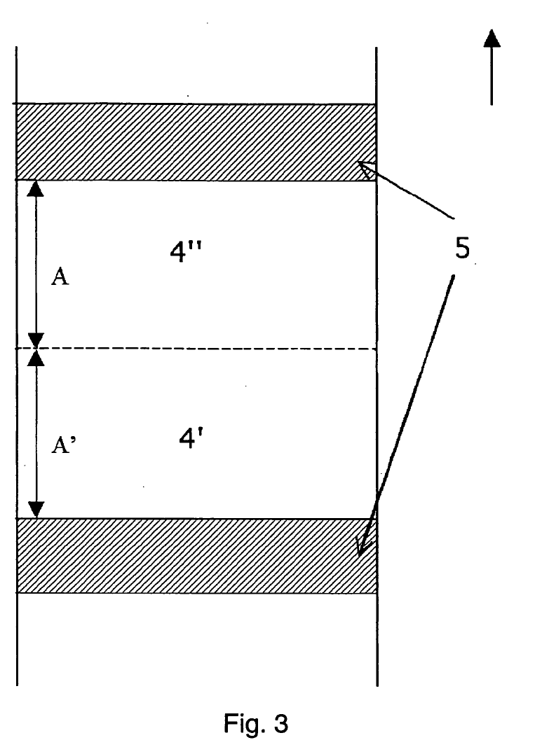

FIG. 3 is a plan view showing the state of joining the final end of a laminated material 4″ from a first roll and the top end of a laminated material 4′ from a second roll. It is accurately cut at the middle between a sealing zone 5 of the laminated material 4″ and the sealing zone 5 of the laminated material 4′. As shown in FIG. 3, the final end of the laminated material web 4″ at the downstream in the printing step and the top end of the laminated material web 4′ at the upstream in the printing step are cut with an identical length for the distance A and the distance A′ in FIG. 3 and the cut end faces of both of the materials are joined in a temporarily stationary state. The width for the conductive layer may be taken larger than a necessary width for acquiring a sealing property to provide a margin capable of absorbing expansion and contraction of paper. The joining is applied precisely in a printing press during high speed printing by utilizing an automatic joining device and can be conducted at a mass production level by a large-scaled flexographic printing press or photogravure printing press.

As described above, the top end of the web-form support layer at the upstream and the rear end of the web-form support layer at the downstream are joined to form a longer web-form support layer. The obtained web can be stored as a roll. Alternatively, it can be continuously supplied to the downstream step without storage.

For the web, a container design is printed indirectly or directly to the outer surface of the web-form support layer in the printing step. Here, the phrase of “indirectly or directly” means that a plastic laminate layer, a film layer, an adhesive layer, an anchor coat layer or the like may also be laminated between the printed layer for a pattern or design and the support layer surface.

Identical or different kind of single or multiple thermoplastic layers are formed simultaneously or successively to the printed outer surface and inner surface of the web-form support layer. As a result, single or multiple outermost layers and an innermost layer are formed. Further, for facilitating the formation of the container in the midway step, ruled lines (folds or creases) are formed optionally to the laminated material.

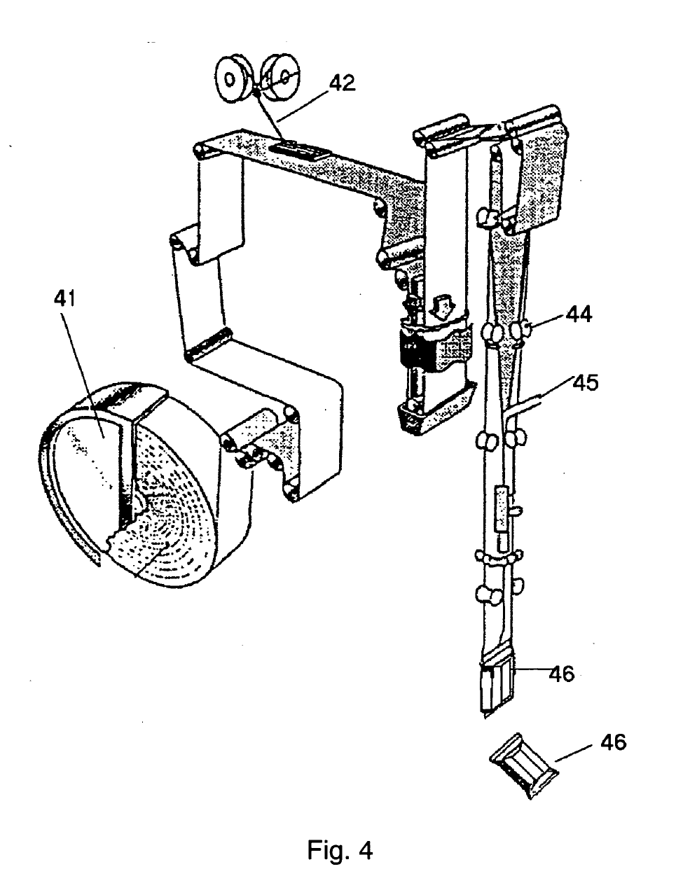

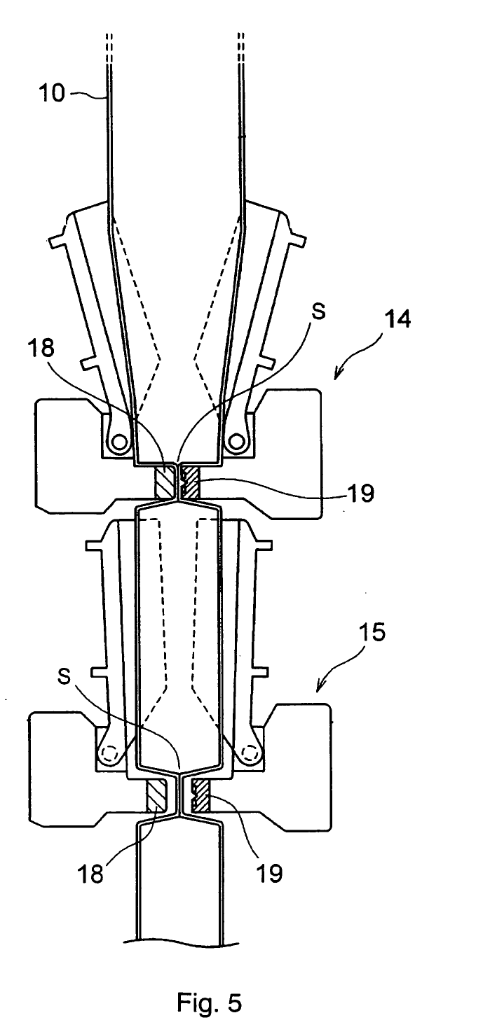

A method of heat sealing the laminated material in an embodiment of the invention is to be described with reference to FIG. 4 and FIG. 5. FIG. 4 is a schematic view for a packaging and filling machine used in the invention.

The laminated material of the invention, that is, a web-form laminated material comprising a support layer, a thermoplastic innermost layer and a conductive layer is provided. A rolled web-form laminated material 41 is loaded on a packaging and filling machine, and the laminated material is delivered from the roll 41 and conveyed into the filling machine. A web-form laminated material under conveyance is attached with a strip tape for longitudinal sealing by an applicator 42 and then formed into a tubular shape while lowering by a roller 44. It is applied with longitudinal sealing in the longitudinal direction of the laminated material and formed into a liquid tight state with no liquid leakage. In case of joining the strip tape for longitudinal sealing to one end of the laminated material by high-frequency induction heating, the conductive layer is laminated also at its one end 7. Further, in case of applying the longitudinal sealing by the high-frequency induction heating, the conductive layer is laminated also to both the ends 7 and 7 of the laminated material web for forming heat-sealing zones by the high-frequency induction heating.

A liquid foodstuff is poured fully into the laminated material tube from a filling pipe 45.

A heat-sealing zone is formed by the high-frequency induction heating in the traversing direction of the thus filled tube, under a liquid surface on every predetermined interval and then transversal sealing is conducted by a transversal sealing device (shown in FIG. 5).

Then, the center for each sealing zone described is cut by a cutting knife, etc. to form individual containers 46 which are folded along the creases if necessary to form each into a final shape.

FIG. 5 is a schematic view of a transversal sealing device of the filling machine.

As shown in FIG. 5, two sets of transversal sealing devices 14 and 15 moving vertically press the filled laminated material tube 10 in the traversing direction by a high-frequency induction heating inductor 19 and a counter jaw 18, heat and cool the same and form a heat sealing zone S on every predetermined interval by high-frequency induction heating to apply transversal sealing.

Then, the center of each sealing zone S described is cut by a cutting knife (not illustrated) to form individual containers.

In addition to the container shape in the embodiment described above, the packaging container in the invention includes, for example, a brick-shape (parallelepiped), as well as hexagonal prism, octagonal prism, tetrahedral shape, gable-top containers and the like.

As has been described above, the following advantageous effect can be obtained according to the invention.

Even for different packaging systems of aseptic packaging and chilled packaging, since a portion of different packaging systems can be diverted or transferred, this enables efficient running/employment/operation of a whole packaging system and, further, this can contribute to the saving of energy and material and reduction of production cost.

This invention enables to form sealing/joining by a novel sealing method and exact treatment is possible within a printing press during high speed printing by utilizing an automatic joining device and it can be conducted at a mass production level of a large-scaled flexographic printing press or photogravure printing press.

According to the method of the invention, the rapid and reliable sealing method can be applied to inexpensive packaging material not containing a metal foil layer at all.

### INDUSTRIAL APPLICABILITY

The paper packaging laminated material, the paper packaging container according to the invention is utilized to packaging containers for containing liquid foodstuffs such as milk, beverages, and the like.

1. A web-form laminated material used for packaging containers comprising at least a support layer and a thermoplastic innermost layer, in which
a conductive layer is laminated between the support layer and the thermoplastic innermost layer at zones where heat-sealing is conducted by high-frequency induction heating for forming the container so that the heat generated by the induction heating is conducted to the innermost layer and
the conductive layer is a thin film/formed layer substantially comprising a metallic conductive material.

2. A laminated material according to claim 1, wherein the conductive layer is a printed layer of a conductive composition containing a conductive filler substantially comprising a metallic conductive material.

3. A laminated material according to claim 1, wherein the conductive layer is a plating layer comprising a metallic conductive material.

4. A laminated material according to claim 1, wherein the conductive layer is a metal vapor deposited layer comprising a metallic conductive material disposed on a vapor deposited tape.

5. A laminated material according to claim 1, wherein the conductive layer is a metal vapor deposited layer comprising a metallic conductive material disposed on the inner surface of a substrate film of a vapor deposited film laminated between the support layer and the thermoplastic innermost layer.

6. A laminated material according to claim 1, wherein the conductive layer is a metal vapor deposited layer comprising a metallic conductive material disposed on the outer surface of a substrate film of a vapor deposited film laminated between the support layer and the thermoplastic innermost layer.

7. A process of producing a web-form laminated material used for packaging containers comprising at least a support layer and a thermoplastic innermost layer, which includes,
providing a plurality of material rolls for the support layer,
delivering web-form support layers successively from the material rolls, printing a conductive layer of a conductive composition containing a conductive filler to the inner surface of the support layer directly or indirectly at zones where heat-sealing is conducted by high-frequency induction heating for forming the container,
printing a container design indirectly or directly to the outer surface of the web-form support layer,
forming identical or different kind of single or multiple thermoplastic layers simultaneously or successively to the printed outer surface and inner surface of the web-form support layer, and then joining the top end of the web-form support layer at the upstream with the rear end of the web-form support layer at the downstream thereby forming a longer web-form support layer.

8. A method of producing a web-form laminated material used for packaging containers comprising at least a support layer and a thermoplastic innermost layer, which includes,
providing a plurality of material rolls for the support layer,
delivering web-form support layers successively from the material rolls, forming a plating layer comprising a metallic conductive material to the inner surface of the support layer at zones where heat-sealing is conducted by high frequency-induction heating for forming the container,
printing a container design indirectly or directly to the outer surface of the web-form support layer,
forming identical or different kind of single or multiple thermoplastic layers simultaneously or successively to the printed outer surface and inner surface of the web-form support layer, and
joining the top end of the web-form support layer at the upstream with the rear end of the web-form support layer at the downstream thereby forming a longer web-form support layer.

9. A method of producing a web-form laminated material used for packaging containers comprising at least a support layer and a thermoplastic innermost layer, which includes,
providing a plurality of material rolls for the support layer,
delivering web-form support layers successively from the material rolls, laminating an vapor deposited film comprising a substrate film and a metal vapor deposited layer of a metallic conductive material formed on the inner surface or the outer surface of the substrate film to the inner surface of the support layer including zones where heat-sealing is conducted by high-frequency induction heating for forming the container,
printing a container design indirectly or directly to the outer surface of the long web-form support layer,
forming identical or different kind of single or multiple thermoplastic layers simultaneously or successively to the printed outer surface and inner surface of the web-form support layer, and
joining the top end of the web-form support layer at the upstream with the rear end of the web-form support layer at the downstream, thereby forming a longer web-form support layer.

10. A method of heat sealing a laminated material, which includes,
providing a web-form laminated material that is the laminated material used for packaging container comprising at least of a support layer and a thermoplastic layer, in which
a conductive layer is laminated between the support layer and the thermoplastic innermost layer at zones where heat-sealing is conducted by high-frequency induction heating for forming the container so that the heat generated by the induction heating is conducted to the innermost layer, and the conductive layer is a printed layer formed by printing a conductive composition containing a conductive filler or a plating layer comprising a metallic conductive material,
forming the web-form laminated material into a tubular shape and applying a longitudinal seal in the longitudinal direction,
filling the laminated material tube with a liquid foodstuff,
forming heat-sealing zones by the high-frequency induction heating every predetermined interval in the traversing direction of the filled tube, and
cutting the center of each sealing zone, thereby forming individual containers.

11. A packaging container formed of a laminated material comprising at least a support layer and a thermoplastic innermost layer in which
a conductive layer of a thin film/formed layer substantially comprising a metallic conductive material is formed at zones where heat-sealing is conducted by high-frequency induction heating for forming the container, the innermost layer is melted or softened by the heat generated by the induction heating to form a sealing zone with the opposing softened or melted innermost layer.
